(19) United States
(12) Patent Application Publication
(10) Pub. No.: US 2006/0244612 A1
(43) Pub. Date: Nov. 2, 2006

(54) Apparatus (Bullet mounted RFID) for the purpose of generating a tracking signal from a deployed bullet

(76) Inventors: Charles Franklin Pridmore JR., Winfield, AL (US); Peter G. Babendreier, Laurel, MD (US)

Correspondence Address: RelativeImpact Inc., P.O. Box 259, Chester, MD, 21619, US

(21) Appl. No.: 11/095,953

(22) Filed: Apr. 1, 2005

Related U.S. Application Data
(60) Provisional application No. 60/562,997, filed on Apr. 19, 2004.

(51) Int. Cl. G08B 23/00

(52) U.S. Cl. 340/573.2

(57) ABSTRACT

An apparatus (bullet mounted RFID) for the purpose of generating a tracking signal from a deployed bullet. with Plastic carrier assembly that is universal to the modern and primitive bullet configurations currently on the market, Self contained RFID Electronics which consist of RFID Chip, battery, antenna and which are protected by a plastic molded housing, This apparatus does not negatively impact bullet performance or ballistics and this apparatus deploys RFID Technology in the field that will assist in the successful recovery of harvested game.

### CROSS REFERENCE TO RELATED APPLICATIONS

This is a continuation in part of Ser. No. 60/562,997, filed on Apr. 19, 2004.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of RFID Technology and more specifically to an apparatus (Bullet mounted RFID) for the purpose of generating a tracking signal from a deployed bullet.

Since May 2003 Charles F. Pridmore Jr. and Peter G. Babendreier (Inventors) have been developing the listed apparatus for use by sportsmen, etc. This device takes the elements of RFID Technology and incorporates it into a bullet which will help to eliminate wasted game by assisting both experienced and novice sportsmen in tracking targeted and struck game animals. During over 60 years of personal hunting experience by the inventors, they have familiarity with the disappointment in lost trophy's due to ineffective marksmanship, impossible terrain and weather conditions or a combination of multiples of these listed issues.

We are not aware of any similar devices using RFID Technology.

Earlier Technologies were prohibitive based upon size issue with the RFID Chip technology.

With reduced component sizes, Battery and RFID Chip and the development of antenna technology, it now becomes possible to deploy this type of device as an internal component of a modern bullet without any loss of performance, accuracy and functionality.

### BRIEF SUMMARY OF THE INVENTION

The primary object of the invention (RFID Carrier) is a device that is incorporated into the internal structure of a bullet and contains RFID Electronics that will emit a signal that can be utilized to locate harvested game.

Another object of the invention is this apparatus will universally function in full lead, copper jacketed, sabot bullets.

Another object of the invention is this apparatus will function with both solid and hollow point bullets.

A further object of the invention is this apparatus can be self contained within modern and primitive style bullets

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an apparatus (Bullet mounted RFID) for the purpose of generating a tracking signal from a deployed bullet.

comprised of multiple components IE piston, shock cup and hollow point cup, that are universal to the modern and primitive bullet configurations currently on the market, Self contained RFID Electronics which consist of RFID Chip, battery, antenna and which are protected by a plastic molded housing, This apparatus does not negatively impact bullet ballistics and performance, and this apparatus deploys RFID Technology in the field that will assist in the successful recovery of harvested game.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a cross section view of the invention.

FIG. 2 is a perspective view of the bullet casting.

FIG. 3 is a perspective view of the shock cup.

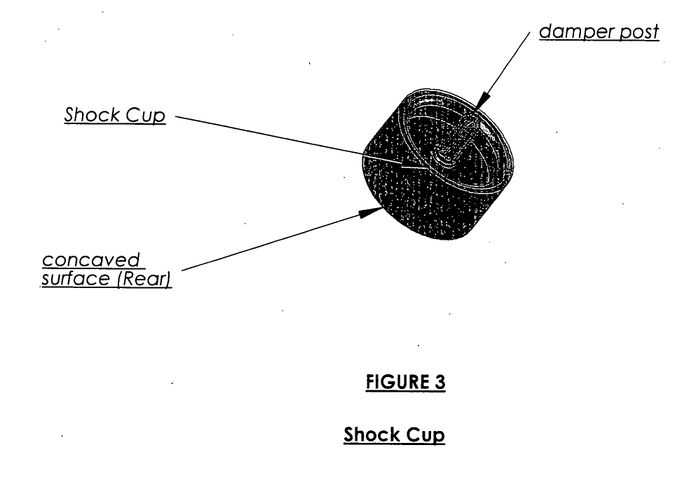

FIG. 4 is a perspective view of the piston.

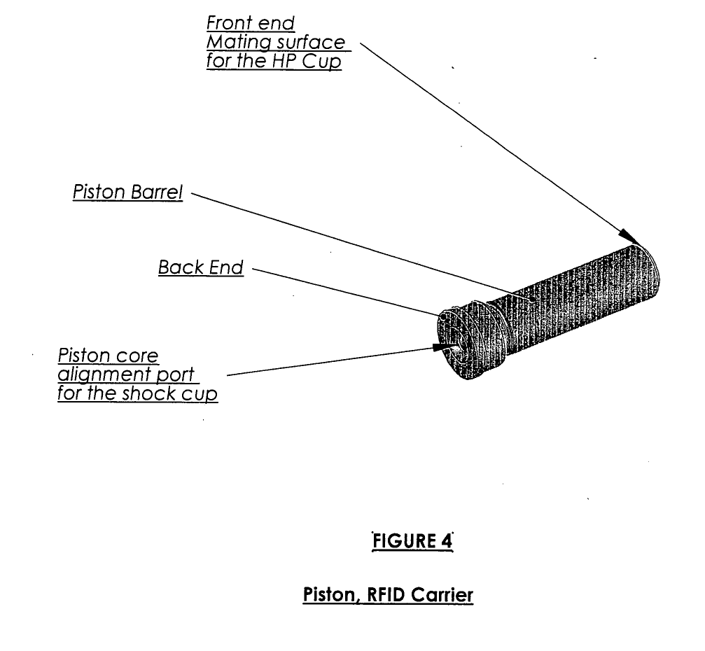

FIG. 5 is a perspective view of the hollow point cup

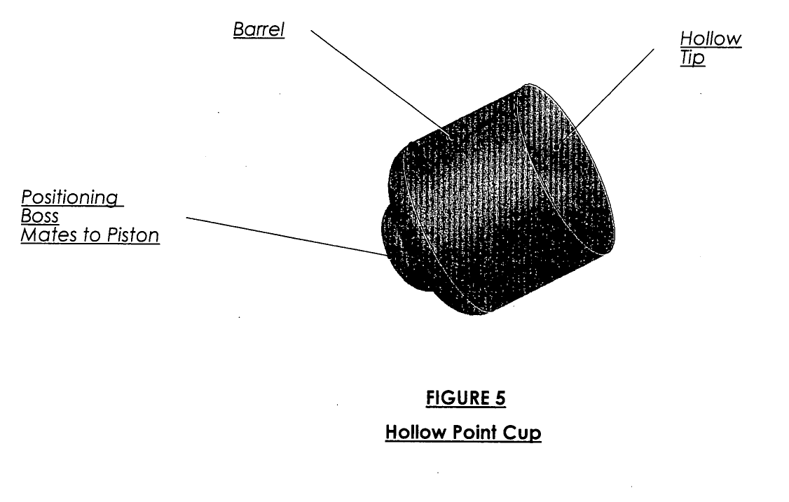

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

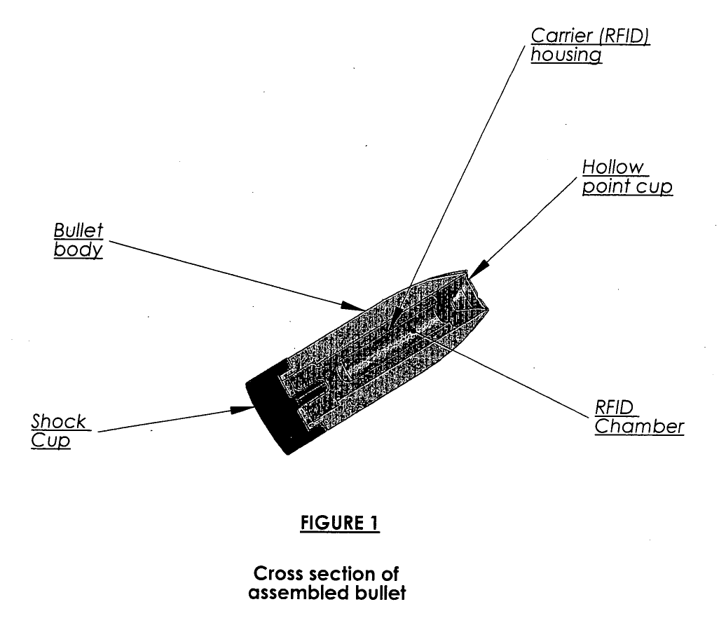

Turning first to FIG. 1 there is shown the bullet assembly. This arrangement of components of the invention acts as the housing and carrier for the RFID Electronics. This is also the deployment platform for the RFID Electronics. The piston is to be constructed of a molded or machined material, be light weight, aerodynamic and will not impede the performance, balance or ballistics of the bullet assembly. The shock cup is to be constructed of a molded material and will function as a gas seal and dampening device of the assembly, it will follow the bullet down the gun barrel upon powder ignition creating an efficient gas seal, in addition the dampening post element of the shock cup will dampen and cushion the electronics against forces created at powder ignition. The shock cup will then separate from the other assembly components after the assembly deploys from the gun barrel. The hollow point cup is to be constructed from molded or cast material and will act as the deployment mechanism when the bullet assembly impacts the target. Upon impact the bullet casting will deform, through the expansion grooves and through the movement of the hollow point cup through the center of the bullet casting, this action will force the RFID Carrying Piston out of the bullet casting through the rear of the bullet. This deployment will leave the signal generating RFID Piston in the target for tracking and location.

The bullet casting is shaped so it can house the RFID piston which carries the RFID, Battery and Antenna and will separate from the bullet assembly as the expansion on impact deforms the projectile upon impact. This will leave the piston embedded in the target and the RFID component will transmit signals to a reader carried by the marksman. This will enable tracking the target animal and recovering the harvest.

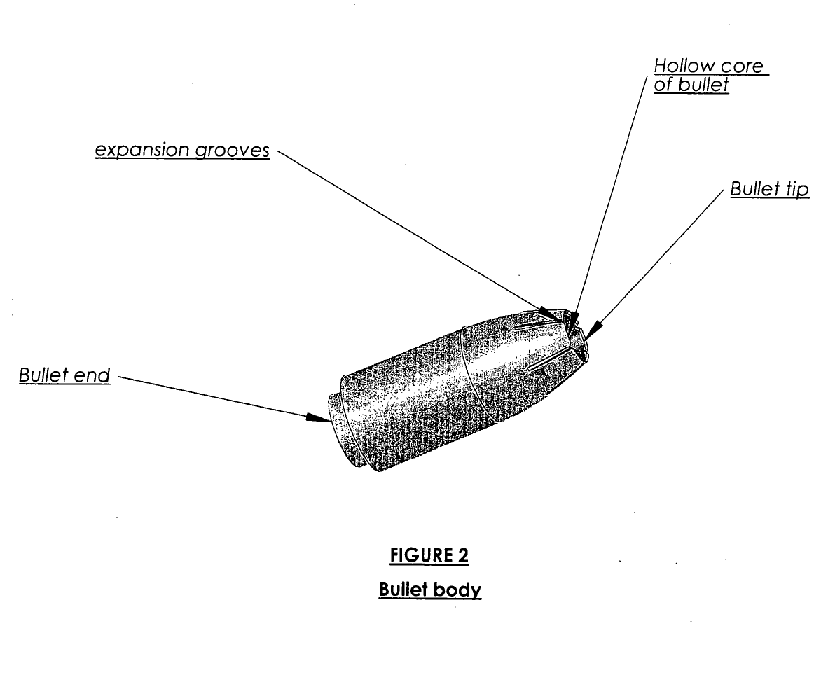

Next in review of FIG. 2 note that this is the bullet casting. As discussed in the FIG. 1 section, the bullet can be seen showing the locating flange for the shock cup, the expansion groove configuration and the hollow barrel in which the piston is press fitted.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An apparatus (Bullet mounted RFID) for the purpose of generating a tracking signal from a deployed bullet.
comprising:
Bullet casting that is universal to the modern and primitive bullet configurations currently on the market;
Self contained RFID Electronics which consist of RFID Chip, bakery, antenna and which are protected by a RFID Piston.
Plastic shock cup for dampening powder discharge recoil.
Plastic hollow point that will function as a cushion on impact and as the ejection mechanism to the piston.
This apparatus does not negatively impact bullet performance and Ballistics and this apparatus deploys RFID Technology in the field that will assist in the successful recovery of harvested game.
